(19) United States
(12) Patent Application Publication
(10) Pub. No.: US 2025/0280857 A1
(43) Pub. Date: Sep. 11, 2025

(54) DEGRADATION-RESISTANT ALDEHYDE-CONTAINING COMPOSITIONS

(71) Applicant: ZOOMESSENCE, INC., HEBRON, KY (US)

(72) Inventors: Charles Pershing BEETZ, BUTLER, KY (US); Ki Yul CHO, PORTAGE, MI (US); Robert TYSZKIEWICZ, UNION, KY (US); Steven Charles HARDEK, CINCINNATI, OH (US); Daniel Michael SCHLIPF, EDGEWOOD, KY (US)

(21) Appl. No.: 18/862,545

(22) PCT Filed: May 1, 2023
(86) PCT No.: PCT/US2023/066425

§ 371 Date: Nov. 3, 2024

Related U.S. Application Data
(60) Provisional application No. 63/337,310, filed on May 2, 2022.

(51) Int. Cl. A23L 2/56; A23L 2/39; A23L 2/66; A23L 29/212; A23L 29/288; A23L 29/30

(52) U.S. Cl. CPC A23L 2/56; A23L 2/39; A23L 2/66; A23L 29/212; A23L 29/288; A23L 29/35

(57) ABSTRACT

Aldehyde-containing dry powder compositions are described, including carrier, emulsifier, and at least one aldehyde ingredient encapsulated in the carrier, wherein the aldehyde-containing powder composition has a Twenty-Eight Day Retention Value of at least 93%, and contains no alcohols or propylene glycol.

### CROSS-REFERENCE TO RELATED APPLICATIONS

The priority under 35 USC § 119 of U.S. Provisional Patent Application 63/337,310 filed May 2, 2022 in the names of Charles Pershing Beetz, Ki Yul Cho, Robert Tyszkiewicz, Steven Charles Hardek, and Daniel Michael Schlipf for “DEGRADATION-RESISTANT ALDEHYDE-CONTAINING COMPOSITIONS” is hereby claimed, and the disclosure thereof is hereby incorporated herein by reference, in its entirety, for all purposes.

### FIELD

The present disclosure relates generally to degradation-resistant aldehyde-containing compositions.

### DESCRIPTION OF THE RELATED ART

Currently, in the manufacture and commercialization of aldehyde-containing compositions, the compositions may be supplied in the form of (i) aqueous emulsions, (ii) oils solubilized in solvents such as ethanol, propylene glycol, or benzyl alcohol, or (iii) washed compositions that are processed to remove water insoluble components. Such compositions may for example include flavor compositions and fragrance compositions that are produced and packaged for transport, storage, and subsequent use, which may involve processing with additional material(s) to constitute final products.

Each of the foregoing approaches has associated deficiencies.

Aqueous emulsions have the disadvantage that the composition is susceptible to emulsion instabilities in the final product. Compositions of oils solubilized in solvents such as ethanol and propylene glycol have the disadvantage of chemical modifications associated with solvent reactions in the composition, in addition to issues of safety and toxicity. Washed compositions when including organoleptic ingredients have the inherent problem of deficient organoleptic profiles attributable to the washing process.

The foregoing deficiencies are increased by the tendency of aldehyde chemical moieties in the composition to degrade and form acetals and other reaction products that impair the properties of the composition as well as products produced therefrom. For example, degradation of aldehyde flavor ingredients may severely diminish the taste, aroma, appearance, and consistency of a flavor composition and its subsequent formulation product. As another example, degradation of aldehyde fragrance ingredients can significantly reduce or otherwise compromise the desired scent or aroma of the ultimate product.

A further disadvantage is encountered, when the aldehyde-containing composition is prepared as an aqueous emulsion of emulsified ingredients, or as a solvent composition of oils, since the resulting composition has a substantial content of water or solvent that markedly increases the composition volume and the associated costs and complexity of packaging, transport, and processing of the composition for subsequent use.

In consequence, the art continues to seek improvements in degradation-susceptible aldehyde-containing compositions.

### SUMMARY

The present disclosure relates to degradation-resistant aldehyde-containing compositions.

In one aspect, the disclosure relates to an aldehyde-containing dry powder composition, comprising carrier, emulsifier, and at least one aldehyde ingredient encapsulated in the carrier, wherein the aldehyde-containing dry powder composition has a Twenty-Eight Day Retention Value of at least 93%, and contains no alcohols or propylene glycol.

In a further aspect, the disclosure relates to a method of using the degradation-resistant aldehyde-containing dry powder composition of the present disclosure, comprising formulating or processing the degradation-resistant aldehyde-containing powder composition with one or more additional components to constitute a final formulation product.

Other aspects, features and embodiments of the disclosure will be more fully apparent from the ensuing description and appended claims.

### BRIEF DESCRIPTION OF THE DRAWINGS

FIG. 1 shows results of flavor retention profiles of hexanal, 2-hexenal, benzaldehyde, vanillin, and 4-(p-hydroxyphenyl)-2-butanone, in a dry flavor powder composition of the present disclosure (“Dry Flavor Powder Composition”), and in respective liquid flavor compositions of: ethanol (“Ethanol Composition”); and propylene glycol (“Propylene Glycol Composition”).

FIG. 2 is a graph of the concentration (%), as a function of storage time in days, over a 28-day test period, of acetal reaction products formed by reaction of aldehyde flavor ingredients in an ethanol liquid flavor composition (“Ethanol Acetal”) and acetal reaction products formed by reaction of aldehyde flavor ingredients in a polyethylene glycol liquid flavor composition (“PG Acetal”).

### DETAILED DESCRIPTION

The present disclosure relates to degradation-resistant aldehyde-containing compositions.

As used herein, the singular forms “a”, “an”, and “the” include plural referents unless the context clearly dictates otherwise.

As used herein, the term “dry” in reference to aldehyde-containing powder compositions of the present disclosure means that the powder composition does not contain more than 5 wt % moisture, based on the total weight of the powder composition.

As used herein, “Twenty-Eight Day Retention Value” in application to an aldehyde ingredient means the percent concentration of the aldehyde ingredient originally present in a composition that remains after 28 days storage of the composition at 25° C., wherein the percent concentration of the aldehyde ingredient is determined by gas chromatography/mass spectrometry (GC/MS) using a solution of methylene chloride and methanol in which the aldehyde ingredient-containing composition is solubilized, and wherein methylene chloride and methanol are present in the solution in a ratio of 2:1 by volume.

As used herein in reference to aldehyde-containing dry powder compositions of the present disclosure, “ready-to-drink” and its abbreviation “RTD” means that the aldehyde-containing dry powder composition upon mixing with a liquid beverage medium at the point of use for consumption, e.g., a liquid beverage medium such as water, alcohol, aqueous alcohol solution, or other aqueous, non-aqueous, alcoholic, non-alcoholic, or other liquid beverage medium, produces a drinkable flavored beverage product.

The disclosure, as variously set out herein in respect of features, aspects and embodiments thereof, may in particular implementations be constituted as comprising, consisting, or consisting essentially of, some or all of such features, aspects and embodiments, as well as elements and components thereof being aggregated to constitute various further implementations of the disclosure. The disclosure contemplates such features, aspects and embodiments in various permutations and combinations, as being within the scope of the invention. The disclosure may therefore be specified as comprising, consisting or consisting essentially of, any of such combinations and permutations of these specific features, aspects and embodiments, or a selected one or ones thereof.

In one aspect, the disclosure relates to an aldehyde-containing dry powder composition, comprising carrier, emulsifier, and at least one aldehyde ingredient encapsulated in the carrier, wherein the aldehyde-containing powder composition has a Twenty-Eight Day Retention Value of at least 93%, and contains no alcohols or propylene glycol. As used in such context, the term “alcohols” excludes polyvinyl alcohol (PVA), and PVA may correspondingly be present in aldehyde-containing dry powder compositions of the present disclosure.

The aldehyde-containing dry powder composition may be of any suitable type, and may for example be or comprise a food, beverage, fragrance, paint, pigment, flavor, pharmaceutical, therapeutic, medication, homeopathic, biological, probiotic, construction, formulating, or other type of composition, as well as mixtures, blends, composites, and combinations of two or more of the foregoing.

In various embodiments, the aldehyde-containing dry powder composition may be a precursor or intermediate composition in which the aldehyde ingredient(s) provides or is constituted to confer specific properties, e.g., organoleptic properties, when subsequently processed or formulated with additional material(s) to constitute final products.

In embodiments in which the aldehyde ingredient(s) comprises an organoleptic aldehyde ingredient, the aldehyde ingredient(s) may for example comprise aldehyde flavor ingredients that are used in the aldehyde-containing dry powder compositions of the present disclosure for production of flavored final products, such as foods, beverages, and other edible or ingestible products, e.g., nutritional supplements, pharmaceuticals, therapeutics, medications, homeopathics, biologicals, and probiotics.

In various embodiments, the aldehyde-containing dry powder composition of the present disclosure may comprise one or more aldehyde flavor ingredients, providing an aldehyde-containing dry flavor powder composition that when added to liquid such as water, alcohol, aqueous alcohol, or other liquid beverage medium, produces a ready-to-drink (RTD) flavored beverage product. The RTD flavored beverage product may be of any suitable type, and may include colas, sports drinks, nutrition drinks, seltzers, etc.

Organoleptic aldehyde ingredient(s) in other embodiments may for example comprise aldehyde fragrance ingredients that are in aldehyde-containing dry powder compositions of the present disclosure for production of scented or aromatic final products, such as perfumes, colognes, toilet waters, shampoos, soaps, deodorants, detergents, body washes, air fresheners, candles, waxes, apparel, packaging, cosmetics, hygiene products, skincare products, detergents, cleaning products, and aromatherapy products, although the disclosure is not limited thereto.

The aldehyde ingredient(s) in the aldehyde-containing powder composition may be of any suitable type or types. The aldehyde ingredient(s) in various embodiments may for example comprise aldehyde ingredient(s) selected from the group consisting of: acetaldehyde; acetal B; alpha-amylcinnamaldehyde; benzaldehyde; 2-benzofurancarboxaldehyde; bis-(methylthio)methane; 4-(methylthio)butanal; alpha-butylcinnamaldehyde; butyraldehyde; cinnamaldehyde; cis-4-heptenal; cis-5-isopropenyl-cis-2-metal cyclopentane-1-carboxaldehyde; citronelloxyacetaldehyde; cuminaldehyde; decanal; 2-decenal; 4-decenal; (+/−)-cis- and trans-1,2-dihydroperillaldehyde; 2,4-dimethyl benzaldehyde; 2,6-dimethyloctanal; 3,7-dimethyloctanal; 2,8-dithianon-4-en-4-carboxaldehyde; divanillin; 2-dodecenal; (Z)-4-dodecenal; 2,3-epoxydecanal; 4,5-epoxy-(E)-2-decenal; 2,3-epoxyheptanal; 2,3-epoxyoctanal; p-ethoxybenzaldehyde; 4-ethylbenzaldehyde; 2-ethylbutyraldehyde; 2-ethyl-2-heptenal; 2-ethyl-2-hexenal; 1-ethyl-2 pyrrolecarboxaldehyde; ethyl vanillin; ethyl vanillin beta-D-glucopyranoside; ethyl vanillin isobutyrate; farnesal; 2-formyl-6,6-dimethylbicyclo(3.3.1)hept-2-ene; furfural; 2-furfurylidenebutyraldehyde; 2,4-heptadienal; heptanal; 2-heptenal; trans-,trans-2,4-hexadienal; hexanal; 2-hexenal; 3-hexenal; cis-3-hexenal; trans-3-hexenal; cis-4-hexenal; trans-4-hexenal; alpha-hexylcinnamaldehyde; 2-hexylidenehexanal; 4-hydroxybenzaldehyde; hydroxycitronellal; 4-hydroxy-3,5-dimethoxybenzaldehyde; 2-hydroxy-4-methoxybenzaldehyde; 2-hydroxy-4-methylbenzaldehyde; isobutyraldehyde; 2-isopropyl-5-methyl-2-hexenal; p-isopropylphenylacetaldehyde; 3-(p-isopropylphenyl)propionaldehyde; IVY carbaldehyde; lauric aldehyde; p-menth-1-ene-9-al; 3-mercapto-2-methylpentanal; p-methoxy-alpha-methylcinnamaldehyde; o-methoxybenzaldehyde; p-methoxybenzaldehyde; o-methoxycinnamaldehyde; p-methoxycinnamaldehyde; 2-methyl-3-(2-furyl)acrolein; 2-methyl-2-butenal; 3-methyl-2-butenal; 2-methylbutyraldehyde; 3-methylbutyraldehyde; alpha-methylcinnamaldehyde; p-methylcinnamaldehyde; 3-(3,4-methylenedioxyphenyl)-2-methylpropanal; 5-methylfurfural; 3-(5-methyl-2-furyl)-butanal; 3-(5-methyl-2-furyl)prop-2-enal; 3-[(2-methyl-3-furyl)thio]butanal; 6-methylheptanal; 3-methylhexanal; 1-methyl-1H-pyrrole-2-carboxaldehyde; 4-methyl-2-(methylthiomethyl)-2-hexenal; 5-methyl-2-(methylthiomethyl)-2-hexenal; 4-methyl-2-(methylthiomethyl)-2-pentenal; 2-methyloctanal; (+/−)-6-methyloctanal; 2-methyl-2-octenal; 2-methylpentanal; 2-methyl-2-pentenal; 4-methyl-2-pentenal; 2-methyl-4-phenylbutyraldehyde; 3-methyl-2-phenylbutyraldehyde; 5-methyl-2-phenyl-2-hexenal; 4-methyl-2-phenyl-2-pentenal; 2-methyl-2-(methyldithio)propanal; 2-methyl-3-(p-isopropylphenyl)propionaldehyde; 2-methylthioacetaldehyde; 3-(methylthio)butanal; 2-((methylthio)methyl)-2-butenal; 2-(methylthiomethyl)-3-phenylpropenal; 5-methyl-2-thiophenecarboxaldehyde; 3-(methylthio)propionaldehyde; 2-methyl-2-tolylpropionaldehyde (mixed o-, m-, p-); 12-methyltridecanal; 2-methylundecanal; (+/−)-2-(5-methyl-5-vinyltetrahydrofuran-2-yl)propionaldehyde; myristaldehyde; 2,4-nonadienal; 2-trans-6-trans-nonadienal; 2,6-nonadienal diethyl acetal; nonanal; nona-2,4,6-trienal; 2-nonenal; cis-6-nonenal; 9-octadecenal; trans-,trans-2,4-octadienal; 2-trans-6-trans-octadienal; octanal; 2-octenal; cis-5-octenal; paraldehyde; 2,4-pentadienal; 2-pentenal; 4-pentenal; perillaldehyde; phenylacetaldehyde; 2-phenyl-2-butenal; (+/−)-2-phenyl-4-methyl-2-hexenal; 2-phenyl-4-pentenal; 3-phenyl-4-pentenal; 2-phenyl-3-(2-furyl)-prop-2-enal; 2-phenylpropionaldehyde; 3-phenylpropionaldehyde; piperonal; 1,3-p-menthadien-7-al; propionaldehyde; pyruvaldehyde; salicylaldehyde; tetradic-2-enal; (Z)-8-tetradecenal; tolualdehydes (mixed o-, m-, p-); p-tolylacetaldehyde; 2-(p-tolyl)-propionaldehyde; 2-trans,6-cis-dodecadienal; 2-trans-6-cis-nonadienal; trans-4-nonenal; trans-,trans-2,4-dodecadienal; tridecanal; 2-trans-,4-cis,7-cis-tridecatrienal; 2-tridecenal; 2,6,6-trimethyl-1 and 2-cyclohexen-1-carboxaldehyde; 2,6,6-trimethylcyclohexa-1,3-dienyl methanal; 2,6,6-trimethyl-1-cyclohexen-1-acetaldehyde; 2,2,3-trimethylcyclopent-3-en-1-yl acetaldehyde; 3,5,5-trimethylhexanal; 2,4-undecadienal; gamma-undecalactone; undecanal; (E)-4-undecanal; 10-undecenal; 2-undecenal; 9-undecenal; valeraldehyde; vanillin; vanillin acetate; vanillin isobutyrate; veratraldehyde; and combinations of two or more of the foregoing.

The aldehyde ingredient(s) in various other embodiments may for example comprise aldehyde ingredient(s) selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2-pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; undecenal; pentanal; 2-phenyl propionaldehyde; 3-phenyl propionaldehyde; hydroxybenzaldehyde; heliotropine; vanillin; geranial; neral; raspberry ketone; hydroxycitronellal; C₇-C₁₈ fatty aldehydes; 3,5-dimethyl-3-cyclohexene-1-carboxaldehyde; 4-(4-hydroxy-4-methylpentyl)-3-cyclohexene-1-carboxaldehyde; and combinations of two or more of the foregoing, although the disclosure is not limited thereto.

In various embodiments, the aldehyde-containing dry powder composition of the present disclosure may comprise one or more aldehyde flavor ingredients, providing a base or concentrate powder composition that may be subsequently processed with additional material(s), to constitute flavored final products.

In various embodiments of aldehyde-containing flavor dry powder compositions of the present disclosure, the aldehyde ingredient(s) may for example comprise an aldehyde ingredient selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; pentanal; 2-phenyl propionaldehyde; 3-phenyl propionaldehyde; hydroxybenzaldehyde; heliotropine; vanillin; geranial; neral; raspberry ketone; and combinations of two or more of the foregoing, although the disclosure is not limited thereto.

In other embodiments, the aldehyde ingredient(s) in the aldehyde-containing flavor dry powder composition may be selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; and combinations of two or more of the foregoing.

In still other embodiments, the aldehyde ingredient(s) in the aldehyde-containing flavor powder composition may include an aldehyde ingredient selected from the group consisting of benzaldehyde; acetaldehyde; furfural; hexenal; hexenal trans-2; vanillin; and combinations of two or more of the foregoing.

In various embodiments, the aldehyde-containing dry powder composition of the present disclosure may comprise one or more aldehyde fragrance ingredients, providing a base or concentrate powder composition that may be subsequently processed with additional material(s), to constitute scented or aromatic final products. Aldehyde fragrance ingredients that may be employed for such purpose include, without limitation, benzaldehyde, anisic aldehyde, C₇-C₁₈ fatty aldehydes, vanillin, hexyl cinnamic aldehyde, hydroxycitronellal, 3,5-dimethyl-3-cyclohexene-1-carboxaldehyde, 4-(4-hydroxy-4-methylpentyl)-3-cyclohexene-1-carboxaldehyde, etc.

The carrier in the aldehyde-containing powder compositions of the present disclosure may be of any suitable type. In specific embodiments, the carrier may for example include materials such as any one or more of (i) polysaccharide carriers, e.g., starches, modified food starches, native starches, maltodextrins, alginates, pectins, methylcellulose, ethylcellulose, hydrocolloids, inulin, carbohydrates, mono-, di- and tri-saccharides, soluble fibers, or polydextrose; (ii) proteins, e.g., animal proteins, plant proteins, caseinates, gelatins, soy proteins, pea proteins, whey proteins, or milk proteins; (iii) gums, e.g., guar gum, xanthan gum, acacia gum (gum arabic), gellan gum, or caragenan; (iv) esters, e.g., polysorbates, stearic acid esters, or oleic acid esters; and/or (v) lipids and waxes, e.g., coconut oil, medium chain triglyceride (MCT) oils, vegetable oils, sunflower oils, palm oils, carnauba waxes, or bee waxes, although the disclosure is not limited thereto.

In various embodiments, the carrier may be or comprise maltodextrin, cyclodextrin, or gum arabic. In other embodiments, the carrier may be or comprise native starch, hydrolyzed starch or modified starch. Starches of varying types may be advantageously employed in various implementations of the present disclosure. In various embodiments, cellulose, methylcellulose, ethylcellulose, or other cellulosic materials may be employed. Carriers in other embodiments may be whey protein, soy protein, or gelatin. In other implementations, synthetic polymer carriers of varied types may be utilized, such as polyvinylpyrrolidone, polyvinylalcohol, polyacrylamides, polyvinyl acetate, polyethylene oxide, and polyacrylic acid. It will correspondingly be appreciated that the carrier may be widely varied in the broad practice of the present disclosure, as appropriate to at least partially encapsulate the aldehyde ingredient(s) in the aldehyde-containing dry powder composition.

The emulsifier may be of any suitable type, and may for example comprise emulsifier such as Tween® polysorbate, sodium caseinate, low methoxy pectin, gelatin, L-a-dipalmitoyl-phosphatidylcholine (DPPC), cholesterol, polyvinyl alcohol (PVA), sodium stearoyl lactylate, mono- and di-glycerols, ammonium phosphatide, locust bean gum, xanthan gum, citrem, and/or any other emulsifier or combination of emulsifiers that is appropriate to constitute the aldehyde-containing dry powder composition.

It will be recognized that the aldehyde-containing powder composition may utilize a same component as the carrier and emulsifier in specific embodiments of the present disclosure, where such component is effective to at least partially encapsulate the aldehyde ingredient(s) and also is effective to stabilize a suspension that is used to produce, and/or is present in, the aldehyde-containing dry powder composition. The aldehyde-containing dry powder compositions of the present disclosure may be constituted to include carrier, emulsifier, and aldehyde ingredient(s), including compositions in which the carrier and emulsifier are constituted by a same ingredient having carrier and emulsifier properties, in any suitable amounts of the various ingredients, and relative proportions of such ingredients to one another, as determined to be appropriate to provide the desired properties to the final products that are produced with such aldehyde-containing powder compositions.

The aldehyde ingredient(s) loading in the aldehyde-containing dry powder composition of the present disclosure may correspondingly be at any suitable concentration, e.g., an aldehyde ingredient(s) loading of from 2 to 50% by weight, based on weight of the carrier in the aldehyde-containing powder composition. For example, the aldehyde ingredient(s) loading in units of % by weight, based on weight of the carrier in the aldehyde-containing powder composition, may be greater than at least one of 2%, 3%, 4%, 5%, 6%, 7%, 8%, 9%, 10%, 12%, 15%, 18%, 20%, 22%, 25%, 28%, 30%, 32%, 35%, 38%, 40%, 42%, 44%, 45%, 46%, 47%, 48%, and up to 50% by weight, or the aldehyde ingredient(s) loading in units of % by weight, based on weight of the carrier in the aldehyde-containing powder composition, may be in a range in which the lower end point value is one of the foregoing numeric values and the upper end point value is one of the foregoing numeric values exceeding the lower end point value, e.g., a range of from 2% to 40%, a range of from 10% to 50%, a range of from 3% to 30%, a range of from 5% to 42%, a range of from 2% to 20%, a range of from 12% to 35%, or other suitable range providing the desired properties in the aldehyde-containing dry powder composition and the final product produced with such dry powder composition.

The aldehyde-containing dry powder composition of the present disclosure may be formed with any suitable particle size and particle size distribution characteristics. For example, the aldehyde-containing dry powder composition in various embodiments may have a particle size distribution in which at least 50% of powder particles have a size in a range of from 25 μm to 250 μm, although the disclosure is not limited thereto. In various embodiments, the dry powder particles may have sizes in a range of from 50 μm to 400 μm, 75 μm to 350 μm, 80 μm to 300 μm, 100 μm to 250 μm, or in other suitable range. In other embodiments, the aldehyde-containing dry powder composition may have a particle size distribution in which at least 75%, 80%, 85%, 88%, 90%, 91%, 92%, 94%, or 95% of particles in the dry powder composition have particle size of at least one of 80 μm, 85 μm, 90 μm, 95 μm, 100 μm, 110 μm, 120 μm, 130 μm, 140 μm, 150 μm, 160 μm, 170 μm, 180 μm, 190 μm, 200 μm or more, or a particle size in a range in which the lower end point value is one of the foregoing numeric particle size values and the upper end point value is one of the foregoing numeric particle size values exceeding the lower end point value. The aldehyde-containing dry powder composition in various embodiments may have an average particle size that is in a range of from 40 μm to 300 μm, or in other suitable ranges such as 75 to 250 μm, 80 to 200 μm, 85 to 150 μm, 90 to 120 μm, or other lower or higher ranges.

The aldehyde-containing dry powder composition of the present disclosure may in various embodiments have a powder particle void volume that is less than at least one of 15%, 14%, 13%, 12%, 11%, 10%, 9%, 8%, 7%, 6%, 5%, 4%, 3%, 2%, 1%, or 0.5% of the total particle volume, or a powder particle void volume that is in a range in which the lower end point value is one of the foregoing numeric percentage values and the upper end point value is one of the foregoing numeric percentage values exceeding the lower end point value.

The powder particle void volume is determined as a calculated percent of the volume taken up by any air pockets inside a particle. The powder particle void volume measurement relies on a scanning electron microscope (SEM) cross section image to see the internal cross section of a particle for measurement. The powder particle void volume value is reported as a percentage, calculated by the volume of the air (or other gas) pockets/volume of the entire particle defined by the external particle boundaries. The procedure for determining powder particle void volume is as follows: 1) approximately 100 mg of powder is thoroughly mixed in 5 mL of epoxy resin; 2) the resin is cast in a mold (Electron Microscopy Sciences part number 70900) and allowed to cure for one day; 3) after curing, the mold is scored and snapped in half to present a clean face of cross sectioned particles embedded in the resin; 4) microscope imaging analysis is performed between 0.1 and 1 KX at 5 KV, and from the cross-section, image analysis software (Image J, National Institute of Health) is used to measure the cross-sectional diameter of the particle and any cross section of internal voids; 5) the void volume is determined by dividing the sum of void volumes (calculated from V=4/3*π*r\hat{ }3) by the volume of the entire particle and multiplying by 100.

The aldehyde-containing dry powder compositions of the present disclosure may in specific embodiments have a weight percent moisture content that is less than at least one of 7%, 6%, 5%, 4.5%, 4%, 3.5%, 3%, 2.75%, 2.5%, 2.25%, 2%, 1.8%, 1.7%, 1.6%, 1.5%, 1.4%, 1.3%, 1.2%, 1.1%, 1.0%, 0.9%, 0.8%, 0.75%, 0.7%, 0.65%, 0.6%, 0.55%, 0.5%, 0.45%, 0.4%, 0.35%, 0.3%, 0.25%, 0.2%, 0.15%, and 0.1%, based on total weight of the aldehyde-containing dry powder composition, or a powder particle weight percent moisture content that is in a range in which the lower end point value is one of the foregoing numeric percentage values and the upper end point value is one of the foregoing numeric percentage values exceeding the lower end point value.

The aldehyde-containing dry powder compositions of the present disclosure may have a bulk density of any suitable character, and in specific embodiments may for example have a bulk density in a range of from 0.8 to 1.4 g/ml, or bulk density in a range of from 1.0 to 1.2 g/ml, or bulk density in other range providing useful properties and effective processing and end-use character. The bulk density is determined by the following procedure: 1) a calibrated Copley BEP2 25 mL density cup is tared on a scale; 2) the cup is filled until overflowing and the excess is scraped off, 3) the cup containing the powder is re-weighed; and 4) the weight in grams is divided by 25 mL (volume of the cup).

In various embodiments, the aldehyde-containing dry powder compositions of the present disclosure have a Twenty-Eight Day Retention Value of the aldehyde ingredient(s) therein that is greater than at least one of 93%, 93.5%, 94%, 94.5%, 95%, 95.5%, 96%, 96.5%, 97%, 97.5%, 98%, 98.5%, 99%, and 99.5%, and up to 100%, or that is in a range in which the lower end point value is one of the foregoing numeric percentage values and the upper end point value is one of the foregoing numeric percentage values (for example, 100%) exceeding the lower end point value.

In various embodiments, aldehyde-containing dry powder compositions of the present disclosure comprise base or concentrate powder compositions for preparation of drink formulations, such as ready-to-drink (RTD) aldehyde-containing dry powder compositions that are introducible to suitable beverage liquids at the point of use for consumption, to yield an immediately drinkable beverage. The aldehyde ingredient(s) in such RTD composition may include aldehyde flavor ingredient(s) of any of suitable types, to provide the subsequently formed beverage with corresponding desired flavor and taste characteristics. The subsequently formed beverage may be carbonated or non-carbonated, depending on the character of the beverage liquid to which the aldehyde-containing dry powder composition is introduced, or the aldehyde-containing dry powder composition may be constituted with effervescence-producing ingredient(s) to provide a corresponding effervescent drink.

More generally, the aldehyde-containing dry powder compositions of the present disclosure may be constituted with any of a wide variety of dry ingredients therein, including antioxidants, stabilizers, preservatives, solubilizers, anti-agglomeration agents, etc., as may be necessary and/or beneficial to provide desired properties to the composition and/or the final products made therefrom.

The aldehyde-containing dry powder compositions of the present disclosure are able to be produced, packaged, transported, and stored in a dry condition. Accordingly, aldehyde-containing dry powder compositions of the present disclosure achieve a substantial advance in the art over compositions that are supplied in liquid form, such as, for example, liquid flavor compositions or liquid fragrance compositions containing substantial amounts of ethanol, propylene glycol, and/or water, which are characterized by high weights and volumes and temperature constraints, which adversely impact packaging, transport, and storage requirements, as compared with the aldehyde-containing dry powder compositions of the present disclosure.

Aldehyde-containing dry powder compositions of the present disclosure may be formed in any suitable manner and by any appropriate process conditions and processing steps and sequences. In various embodiments, such aldehyde-containing dry powder compositions are formed by spray drying, in which aqueous or other solvent-based suspensions containing the carrier, emulsifier, and aldehyde ingredients are spray dried in contact with suitable drying fluid to produce the aldehyde-containing dry powder composition. Spray drying processes described in U.S. Pat. Nos. 8,939,388, 9,332,776, 9,551,527, 9,861,945, 9,993,787, 10,155,234, 10,252,181, and 10,486,173 may be utilized, but the disclosure is not limited thereto, and other powder-forming processes such as freeze-drying, drum drying, microwave dehydration, extrusion, etc. may also be employed.

The disclosure relates in a further aspect to a method of using the aldehyde-containing dry powder composition of the present disclosure, as variously described herein, comprising formulating or processing the aldehyde-containing dry powder composition, e.g., with one or more additional components, to constitute a final product.

The final product may for example be a product in which the aldehyde ingredient(s) comprises an organoleptic aldehyde ingredient of the final product. For example, the organoleptic aldehyde ingredient may be an aldehyde flavor ingredient, for which the final product may be a food, beverage, nutritional, pharmaceutical, therapeutic, medication, homeopathic, biological, or probiotic product.

The final product may for example be a ready-to-drink (RTD) flavored beverage product that is formed by adding the aldehyde-containing dry powder composition to a drinkable liquid, to form a beverage product, such as a cola, sports, nutrition, seltzer, or other beverage product, having a desired flavor, taste, and aromatic character.

The final product in other embodiments may be a product in which the aldehyde ingredient(s) comprises an organoleptic aldehyde fragrance ingredient of the final product, for final products such as perfumes, colognes, toilet waters, shampoos, soaps, deodorants, detergents, body washes, air fresheners, candles, waxes, apparel, packaging, cosmetics, hygiene products, skincare products, detergents, cleaning products, and aromatherapy products.

The aldehyde-containing dry powder compositions of the present disclosure embody a substantial advance in the art, providing compositions that can be readily transported, stored, and ultimately processed or formulated to constitute final products, without the loss and/or deterioration of aldehyde ingredients and the associated adverse effects on properties that result when propylene glycol, ethanol, and similar reagents are used to produce compositions containing the aldehyde ingredient(s).

The present disclosure reflects the surprising finding that alcohols, propylene glycol, and similar reagents are not necessary to prepare base or concentrate compositions of aldehyde ingredient(s) for subsequent formulation or processing to produce final products containing such aldehyde ingredient(s), and that the aldehyde-containing dry powder compositions of the present disclosure provide stable and superior properties retention of such aldehydes for their intended final product uses.

The features and advantages of the disclosure are further illustrated with reference to the following examples, which are not intended to be construed as in any way limiting the scope of the present disclosure.

### Example 1

Blends of aldehyde flavor components were studied to assess reactions with ethanol and with propylene glycol, as common solvents that are utilized in flavor compositions manufactured for subsequent use in making ready-to-drink beverages and other flavored aqueous formulations. The aldehyde flavors in the flavor blend were hexanal (26.67% by weight), 2-hexenal (26.66% by weight), benzaldehyde (26.67%), vanillin (10% by weight), and 4-(p-hydroxyphenyl)-2-butanone (10% by weight), with all weight percentages based on total weight of the flavor blend.

After compounding the aldehyde flavor blend, an aqueous suspension including the flavor blend, starch carrier, and modified food starch emulsifier was formulated to provide a 10% loading of the flavor blend in the dry powder composition, and the aqueous suspension was spray dried by contacting with drying air that was introduced to the contacting operation at temperature of 43.3° C., to yield the 10% load flavor powder.

For comparison, a liquid flavor composition was made using the same flavor blend at an amount of 10% by weight, based on total weight of the liquid flavor composition, in ethanol or in propylene glycol, as conventionally utilized solvents in liquid flavor compositions.

The spray dried flavor dry powder composition and the liquid flavor compositions were stored at room temperature (25° C.) for 28 days. During this time, the dry powder composition and the liquid flavor compositions were analyzed by gas chromatography/mass spectrometry (GC/MS) to identify changes in flavor composition and the occurrence of reaction byproducts. In the GC/MS analysis, samples were extracted using a methylene chloride and methanol solution. Samples were injected on an Agilent 7890 GC gas chromatograph, and the furnace settings were 60° C. to 230° C. at a temperature ramp of 40° C./minute on an HP-1 column. Results were analyzed using Agilent Chemstation software.

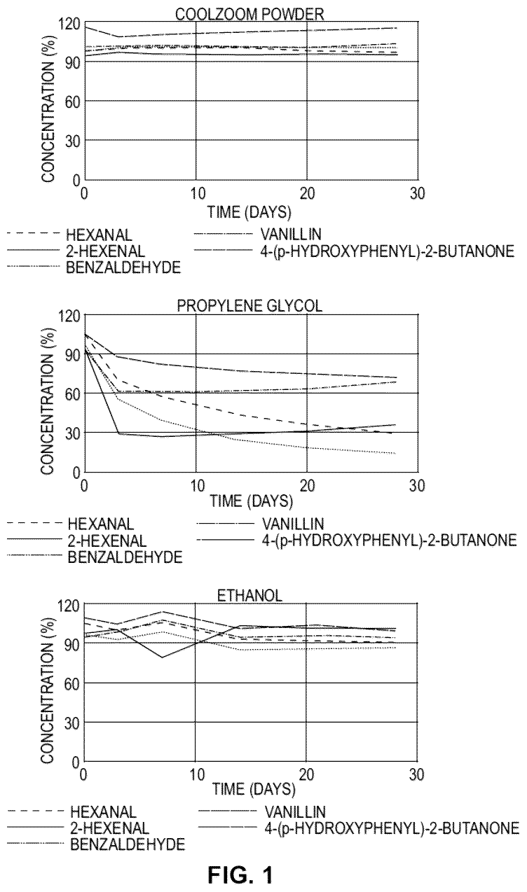

FIG. 1 shows results of flavor retention profiles of hexanal, 2-hexenal, benzaldehyde, vanillin, and 4-(p-hydroxyphenyl)-2-butanone, in the spray dried flavor powder composition of the present disclosure (“CoolZoom Powder”), and in the respective liquid flavor compositions of ethanol (“Ethanol”) and propylene glycol (“Propylene Glycol”).

As shown in FIG. 1, retention of flavor compounds in the CoolZoom Powder was approximately 100% (values greater than 100% were due to analytical method variance) over the 28 day test period. For the CoolZoom Powder, no retention loss was observed from the starting aldehyde flavor oil ingredients in the dry powder composition produced by the spray drying encapsulation process.

By contrast, the flavor ingredients stored in ethanol and the flavor ingredients stored in propylene glycol experienced significant changes in flavor retention over the same 28-day test period. Reactions of ethanol with the flavor aldehydes in the Ethanol liquid flavor composition created variations in flavor composition over time. This was possibly due to reversibility of the aldehyde-ethanol reactions taking place in the Ethanol liquid flavor composition. On the other hand, reactions of the flavor aldehydes with propylene glycol in the Propylene Glycol liquid flavor composition over the same period of time resulted in observed 15%-70% declines in initial flavor composition within the first three days, ultimately leading to 30%-85% reductions in the initial flavor compounds.

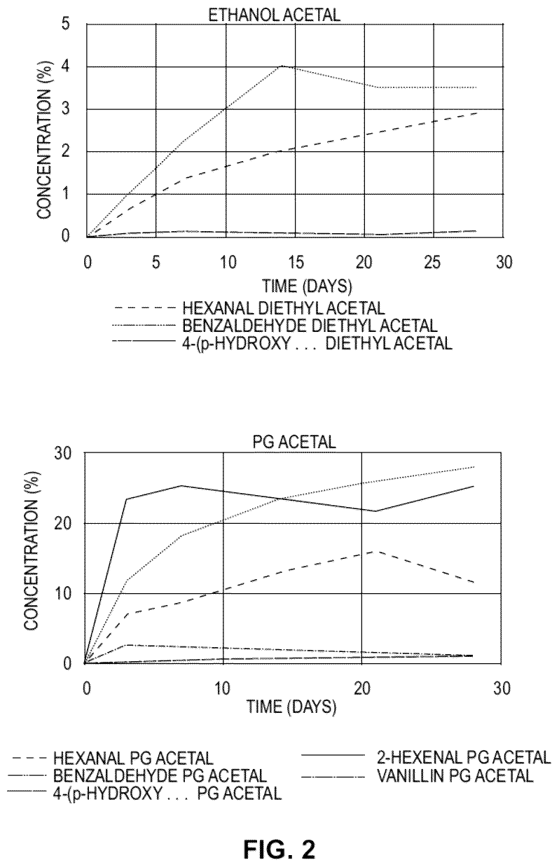

FIG. 2 is a graph of the concentration (%) as a function of time, in days, over the 28-day test period, of acetal reaction products formed by reaction of aldehyde flavor ingredients in the ethanol liquid flavor composition (“Ethanol Acetal”) and acetal reaction products formed by reaction of aldehyde flavor ingredients in the polyethylene glycol liquid flavor composition (“PG Acetal”).

In the ethanol liquid flavor composition (Ethanol Acetal), hexanal and benzaldehyde each reacted to form corresponding diethyl acetals. A small portion of the 4-(p-hydroxyphenyl)-2-butanone in the ethanol liquid flavor composition (Ethanol Acetal) also reacted to form a corresponding diethyl acetal. On the other hand, significant reactions took place with all flavor constituents in the propylene glycol liquid flavor composition (PG Acetal) to form polyethylene glycol-acetal reaction products, and such acetal reaction products ultimately constituted about 30% of the flavor profile.

In Table 1 below, the flavor profile data are shown, including the original aldehyde flavor ingredients, and the acetal reaction products produced after 28 days. The odor type organoleptic data were obtained from www.thegoodscentscompany.com.

TABLE 1
Percentage composition for spray dried powder (CoolZoom
Powder), ethanol liquid composition (Ethanol), and propylene
glycol liquid composition (Propylene Glycol), at 28 days.
Odor Type obtained from www.thegoodscentscompany.com

| | CoolZoom | | Propylene | |
|---|---|---|---|---|
| | Powder | Ethanol | Glycol | Odor Type |
| Original Components of Flavor | | | | |
| Hexanal | 22.88 | 21.48 | 7.08 | Green fatty |
| 2-Hexenal | 27.55 | 29.45 | 10.53 | Green leafy |
| Benzaldehyde | 31.81 | 27.45 | 4.64 | Almond cherry |
| Vanillin | 6.98 | 6.40 | 4.65 | Sweet creamy |
| 4-(p-Hydroxyphenyl)-2- | 8.81 | 7.64 | 5.55 | Sweet berry jam |
| butanone | | | | |
| Reaction Components Created | | | | |
| Hexanal PG acetal | — | — | 11.56 | Green fruity |
| 2-Hexenal PG acetal | — | — | 25.03 | Green fruity |
| Benzaldehyde PG acetal | — | — | 27.76 | Bitter fruity |
| Vanillin PG acetal | — | — | 1.19 | Sweet vanilla |
| 4-(p-Hydroxy . . . PG acetal | — | — | 1.18 | |
| Hexanal diethyl acetal | — | 2.91 | — | Green apple |
| Benzaldehyde diethyl acetal | — | 3.52 | — | Green bitter |
| 4-(p-Hydroxy . . . diethyl acetal | — | 0.16 | — | |
| Other | 1.96 | 0.98 | 0.83 | |
| | 100 | 100 | 100 | |

The data in Table 1 indicated that liquid flavor compositions utilizing ethanol or propylene glycol experienced a significant increase in acetals, while the dry flavor powder composition of the present disclosure maintained original flavor components with essentially complete flavor retention, and no detrimental formation of flavor-impairing acetals.

### PARTICULAR EMBODIMENTS

Embodiment 1. An aldehyde-containing dry powder composition, comprising carrier, emulsifier, and at least one aldehyde ingredient encapsulated in the carrier, wherein the aldehyde-containing dry powder composition has a Twenty-Eight Day Retention Value of at least 93%, and contains no alcohols or propylene glycol.

Embodiment 2. The aldehyde-containing dry powder composition of embodiment 1, wherein the Twenty-Eight Day Retention Value is greater than at least one of 93%, 93.5%, 94%, 94.5%, 95%, 95.5%, 96%, 96.5%, 97%, 97.5%, 98%, 98.5%, 99%, and 99.5%.

Embodiment 3. The aldehyde-containing dry powder composition of embodiment 1, wherein the at least one aldehyde ingredient comprises an aldehyde selected from the group consisting of: acetaldehyde; acetal B; alpha-amylcinnamaldehyde; benzaldehyde; 2-benzofurancarboxaldehyde; bis-(methyl thio)methane; 4-(methylthio)butanal; alpha-butylcinnamaldehyde; butyraldehyde; cinnamaldehyde; cis-4-heptenal; cis-5-isopropenyl-cis-2-metal cyclopentane-1-carboxaldehyde; citronelloxyacetaldehyde; cuminaldehyde; decanal; 2-decenal; 4-decenal; (+/−)-cis- and trans-1,2-dihydroperillaldehyde; 2,4-dimethyl benzaldehyde; 2,6-dimethyloctanal; 3,7-dimethyloctanal; 2,8-dithianon-4-en-4-carboxaldehyde; divanillin; 2-dodecenal; (Z)-4-dodecenal; 2,3-epoxydecanal; 4,5-epoxy-(E)-2-decenal; 2,3-epoxyheptanal; 2,3-epoxyoctanal; p-ethoxybenzaldehyde; 4-ethylbenzaldehyde; 2-ethylbutyraldehyde; 2-ethyl-2-heptenal; 2-ethyl-2-hexenal; 1-ethyl-2 pyrrolecarboxaldehyde; ethyl vanillin; ethyl vanillin beta-D-glucopyranoside; ethyl vanillin isobutyrate; farnesal; 2-formyl-6,6-dimethylbicyclo(3.3.1)hept-2-ene; furfural; 2-furfurylidenebutyraldehyde; 2,4-heptadienal; heptanal; 2-heptenal; trans-,trans-2,4-hexadienal; hexanal; 2-hexenal; 3-hexenal; cis-3-hexenal; trans-3-hexenal; cis-4-hexenal; trans-4-hexenal; alpha-hexylcinnamaldehyde; 2-hexylidenehexanal; 4-hydroxybenzaldehyde; hydroxycitronellal; 4-hydroxy-3,5-dimethoxybenzaldehyde; 2-hydroxy-4-methoxybenzaldehyde; 2-hydroxy-4-methylbenzaldehyde; isobutyraldehyde; 2-isopropyl-5-methyl-2-hexenal; p-isopropylphenylacetaldehyde; 3-(p-isopropylphenyl)propionaldehyde; IVY carbaldehyde; lauric aldehyde; p-menth-1-ene-9-al; 3-mercapto-2-methylpentanal; p-methoxy-alpha-methylcinnamaldehyde; o-methoxybenzaldehyde; p-methoxybenzaldehyde; o-methoxycinnamaldehyde; p-methoxycinnamaldehyde; 2-methyl-3-(2-furyl)acrolein; 2-methyl-2-butenal; 3-methyl-2-butenal; 2-methylbutyraldehyde; 3-methylbutyraldehyde; alpha-methylcinnamaldehyde; p-methylcinnamaldehyde; 3-(3,4-methylenedioxyphenyl)-2-methylpropanal; 5-methylfurfural; 3-(5-methyl-2-furyl)-butanal; 3-(5-methyl-2-furyl)prop-2-enal; 3-[(2-methyl-3-furyl)thio]butanal; 6-methylheptanal; 3-methylhexanal; 1-methyl-1H-pyrrole-2-carboxaldehyde; 4-methyl-2-(methylthiomethyl)-2-hexenal; 5-methyl-2-(methylthiomethyl)-2-hexenal; 4-methyl-2-(methylthiomethyl)-2-pentenal; 2-methyloctanal; (+/−)-6-methyloctanal; 2-methyl-2-octenal; 2-methylpentanal; 2-methyl-2-pentenal; 4-methyl-2-pentenal; 2-methyl-4-phenylbutyraldehyde; 3-methyl-2-phenylbutyraldehyde; 5-methyl-2-phenyl-2-hexenal; 4-methyl-2-phenyl-2-pentenal; 2-methyl-2-(methyldithio)propanal; 2-methyl-3-(p-isopropylphenyl)propionaldehyde; 2-methylthioacetaldehyde; 3-(methylthio)butanal; 2-((methylthio)methyl)-2-butenal; 2-(methylthiomethyl)-3-phenylpropenal; 5-methyl-2-thiophenecarboxaldehyde; 3-(methylthio)propionaldehyde; 2-methyl-2-tolylpropionaldehyde (mixed o-, m-, p-); 12-methyltridecanal; 2-methylundecanal; (+/−)-2-(5-methyl-5-vinyltetrahydrofuran-2-yl)propionaldehyde; myristaldehyde; 2,4-nonadienal; 2-trans-6-trans-nonadienal; 2,6-nonadienal diethyl acetal; nonanal; nona-2,4,6-trienal; 2-nonenal; cis-6-nonenal; 9-octadecenal; trans-,trans-2,4-octadienal; 2-trans-6-trans-octadienal; octanal; 2-octenal; cis-5-octenal; paraldehyde; 2,4-pentadienal; 2-pentenal; 4-pentenal; perillaldehyde; phenylacetaldehyde; 2-phenyl-2-butenal; (+/−)-2-phenyl-4-methyl-2-hexenal; 2-phenyl-4-pentenal; 3-phenyl-4-pentenal; 2-phenyl-3-(2-furyl)-prop-2-enal; 2-phenylpropionaldehyde; 3-phenylpropionaldehyde; piperonal; 1,3-p-menthadien-7-al; propionaldehyde; pyruvaldehyde; salicylaldehyde; tetradic-2-enal; (Z)-8-tetradecenal; tolualdehydes (mixed o-, m-, p-); p-tolylacetaldehyde; 2-(p-tolyl)-propionaldehyde; 2-trans,6-cis-dodecadienal; 2-trans-6-cis-nonadienal; trans-4-nonenal; trans-,trans-2,4-dodecadienal; tridecanal; 2-trans-,4-cis,7-cis-tridecatrienal; 2-tridecenal; 2,6,6-trimethyl-1 and 2-cyclohexen-1-carboxaldehyde; 2,6,6-trimethylcyclohexa-1,3-dienyl methanal; 2,6,6-trimethyl-1-cyclohexen-1-acetaldehyde; 2,2,3-trimethylcyclopent-3-en-1-yl acetaldehyde; 3,5,5-trimethylhexanal; 2,4-undecadienal; gamma-undecalactone; undecanal; (E)-4-undecanal; 10-undecenal; 2-undecenal; 9-undecenal; valeraldehyde; vanillin; vanillin acetate; vanillin isobutyrate; veratraldehyde; and combinations of two or more of the foregoing.

Embodiment 4. The aldehyde-containing dry powder composition of embodiment 1, wherein the at least one aldehyde ingredient comprises an aldehyde selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; undecenal; pentanal; 2-phenyl propionaldehyde; 3-phenyl propionaldehyde; hydroxybenzaldehyde; heliotropine; vanillin; geranial; neral; raspberry ketone; hydroxycitronellal; C₇-C₁₈ fatty aldehydes; 3,5-dimethyl-3-cyclohexene-1-carboxaldehyde; 4-(4-hydroxy-4-methylpentyl)-3-cyclohexene-1-carboxaldehyde; and combinations of two or more of the foregoing.

Embodiment 5. The aldehyde-containing dry powder composition of embodiment 1, wherein the at least one aldehyde ingredient comprises an aldehyde selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; pentanal; 2-phenyl propionaldehyde; 3-phenyl propionaldehyde; hydroxybenzaldehyde; heliotropine; vanillin; geranial; neral; raspberry ketone; and combinations of two or more of the foregoing.

Embodiment 6. The aldehyde-containing dry powder composition of embodiment 1, wherein the at least one aldehyde ingredient comprises an aldehyde selected from the group consisting of: benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; and combinations of two or more of the foregoing.

Embodiment 7. The aldehyde-containing dry powder composition of embodiment 1, wherein the at least one aldehyde ingredient comprises an aldehyde selected from the group consisting of: benzaldehyde; acetaldehyde; furfural; hexenal; hexenal trans-2; vanillin; and combinations of two or more of the foregoing.

Embodiment 8. The aldehyde-containing dry powder composition of embodiment 1, wherein the at least one aldehyde ingredient comprises an aldehyde selected from the group consisting of: benzaldehyde; anisic aldehyde; C₇-C₁₈ fatty aldehydes; vanillin; hexyl cinnamic aldehyde; hydroxycitronellal; 3,5-dimethyl-3-cyclohexene-1-carboxaldehyde; 4-(4-hydroxy-4-methylpentyl)-3-cyclohexene-1-carboxaldehyde; and combinations of two or more of the foregoing.

Embodiment 9. The aldehyde-containing dry powder composition of embodiment 1, wherein the carrier comprises at least one selected from the group consisting of polysaccharides, proteins, gums, esters, lipids, waxes, and synthetic polymers.

Embodiment 10. The aldehyde-containing dry powder composition of embodiment 1, wherein the carrier comprises at least one selected from the group consisting of starches, modified food starches, native starches, maltodextrins, alginates, pectins, methylcellulose, ethylcellulose, hydrocolloids, inulin, carbohydrates, mono-, di- and tri-saccharides, soluble fibers, polydextrose, animal proteins, plant proteins, caseinates, gelatins, soy proteins, pea proteins, whey proteins, milk proteins, guar gum, xanthan gum, acacia gum (gum arabic), gellan gum, caragenan, polysorbates, stearic acid esters, oleic acid esters, coconut oil, medium chain triglyceride (MCT) oils, vegetable oils, sunflower oils, palm oils, carnauba waxes, bee waxes, polyvinylpyrrolidone, polyvinylalcohol, polyacrylamides, polyvinyl acetate, polyethylene oxide, and polyacrylic acid.

Embodiment 11. The aldehyde-containing dry powder composition of embodiment 1, wherein the carrier comprises starch.

Embodiment 12. The aldehyde-containing dry powder composition of embodiment 1, wherein the carrier comprises at least one selected from the group consisting of maltodextrin, cyclodextrin, and gum arabic.

Embodiment 13. The aldehyde-containing dry powder composition of embodiment 1, wherein the carrier comprises at least one selected from the group consisting of cellulose, methylcellulose, and ethylcellulose.

Embodiment 14. The aldehyde-containing dry powder composition of embodiment 1, wherein the carrier comprises at least one selected from the group consisting of whey protein, soy protein, and gelatin.

Embodiment 15. The aldehyde-containing dry powder composition of embodiment 1, wherein the carrier comprises at least one selected from the group consisting of polyvinylpyrrolidone, polyvinylalcohol, polyacrylamides, polyvinyl acetate, polyethylene oxide, and polyacrylic acid.

Embodiment 16. The aldehyde-containing dry powder composition of embodiment 1, wherein the emulsifier comprises at least one selected from the group consisting of polysorbates, sodium caseinate, low methoxy pectin, gelatin, L-a-dipalmitoyl-phosphatidylcholine (DPPC), cholesterol, polyvinyl alcohol (PVA), sodium stearoyl lactylate, mono- and di-glycerols, ammonium phosphatide, locust bean gum, xanthan gum, and citrem.

Embodiment 17. The aldehyde-containing dry powder composition of embodiment 1, wherein the carrier and emulsifier are constituted by a same ingredient having carrier and emulsifier properties.

Embodiment 18. The aldehyde-containing dry powder composition of embodiment 1, wherein aldehyde ingredient(s) loading is from 2 to 50% by weight, based on weight of the carrier in the aldehyde-containing powder composition.

Embodiment 19. The aldehyde-containing dry powder composition of embodiment 1, wherein weight percent aldehyde ingredient(s) loading, based on weight of the carrier in the aldehyde-containing powder composition, is greater than at least one of 2%, 3%, 4%, 5%, 6%, 7%, 8%, 9%, 10%, 12%, 15%, 18%, 20%, 22%, 25%, 28%, 30%, 32%, 35%, 38%, 40%, 42%, 44%, 45%, 46%, 47%, 48%, and up to 50% by weight.

Embodiment 20. The aldehyde-containing dry powder composition of embodiment 1, wherein weight percent aldehyde ingredient(s) loading, based on weight of the carrier in the aldehyde-containing powder composition, is in a range in which the lower end point value is 2%, 3%, 4%, 5%, 6%, 7%, 8%, 9%, 10%, 12%, 15%, 18%, 20%, 22%, 25%, 28%, 30%, 32%, 35%, 38%, 40%, 42%, 44%, 45%, 46%, 47%, 48%, or 50%, and the upper end point value is 120. Of the foregoing numeric values exceeding the lower end point value.

Embodiment 21. The aldehyde-containing dry powder composition of embodiment 1, wherein weight percent aldehyde ingredient(s) loading, based on weight of the carrier in the aldehyde-containing powder composition, is in a range of from 2% to 40%, a range of from 10% to 50%, a range of from 3% to 30%, a range of from 5% to 42%, a range of from 2% to 20%, or a range of from 12% to 35%.

Embodiment 22. The aldehyde-containing dry powder composition of embodiment 1, having a particle size distribution of the powder in which at least 50% of powder particles have a size in a range of from 25 μm to 250 μm.

Embodiment 23. The aldehyde-containing dry powder composition of embodiment 1, wherein at least 75%, 80%, 85%, 88%, 90%, 91%, 92%, 94%, or 95% of particles in the powder composition have particle size of at least one of 80 μm, 85 μm, 90 μm, 95 μm, 100 μm, 110 μm, 120 μm, 130 μm, 140 μm, 150 μm, 160 μm, 170 μm, 180 μm, 190 μm, and 200 μm.

Embodiment 24. The aldehyde-containing dry powder composition of embodiment 1, having an average particle size in a range of from 40 μm to 300 μm.

Embodiment 25. The aldehyde-containing dry powder composition of embodiment 1, wherein powder particles in the powder composition have a powder particle void volume that is less than at least one of 15%, 14%, 13%, 12%, 11%, 1,10%,9%,8%,7%,6%,5%,4%,3%,22%, 1%, or 0.5% of the total particle volume.

Embodiment 26. The aldehyde-containing dry powder composition of embodiment 1, having a weight percent moisture content that is less than at least one of 7%, 6%, 5%, 4.5%, 4%, 3.5%, 3%, 2.75%, 2.5%, 2.25%, 2%, 1.8%, 1.7%, 1.6%, 1.5%, 1.4%, 1.3%, 1.2%, 1.1%, 1.0%, 0.9%, 0.8%, 0.75%, 0.7%, 0.65%, 0.6%, 0.55%, 0.5%, 0.45%, 0.4%, 0.35%, 0.3%, 0.25%, 0.2%, 0.15%, and 0.1%, based on total weight of the aldehyde-containing powder composition.

Embodiment 27. The aldehyde-containing dry powder composition of embodiment 1, having a bulk density in a range of from 0.8 to 1.4 g/ml.

Embodiment 28. A method of using the aldehyde-containing dry powder composition of any one of embodiments 1 to 27, comprising formulating or processing the aldehyde-containing powder composition with one or more additional components to constitute a final product.

Embodiment 29. The method of embodiment 28, wherein the final product is a product in which the at least one aldehyde ingredient comprises an organoleptic aldehyde ingredient of the final product.

Embodiment 30. The method of embodiment 29, wherein the organoleptic aldehyde ingredient is an aldehyde flavor ingredient.

Embodiment 31. The method of embodiment 30, wherein the final product is a product selected from the group consisting of foods, beverages, nutritional supplements, pharmaceutical products, therapeutic products, medication products, homeopathic products, biological products, and probiotic products.

Embodiment 32. The method of embodiment 30, wherein the final product is a ready-to-drink (RTD) flavored beverage product that is formed by adding the aldehyde-containing dry powder composition to a drinkable liquid.

Embodiment 33. The method of embodiment 29, wherein the organoleptic aldehyde ingredient is an aldehyde fragrance ingredient.

Embodiment 34. The method of embodiment 33, wherein the final product is a product selected from the group consisting of perfumes, colognes, toilet waters, shampoos, soaps, deodorants, detergents, body washes, air fresheners, candles, waxes, apparel, packaging, cosmetics, hygiene products, skincare products, detergents, cleaning products, and aromatherapy products.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

1. An aldehyde-containing dry powder composition, comprising carrier, emulsifier, and at least one aldehyde ingredient encapsulated in the carrier, wherein the aldehyde-containing dry powder composition has a Twenty-Eight Day Retention Value of at least 93%, and contains no alcohols or propylene glycol.

2. The aldehyde-containing dry powder composition of claim 1, wherein the Twenty-Eight Day Retention Value is greater than at least one of 93%, 93.5%, 94%, 94.5%, 95%, 95.5%, 96%, 96.5%, 97%, 97.5%, 98%, 98.5%, 99%, and 99.5%.

3. The aldehyde-containing dry powder composition of claim 1, wherein the at least one aldehyde ingredient comprises an aldehyde selected from the group consisting of acetaldehyde; acetal B; alpha-amylcinnamaldehyde; benzaldehyde; 2-benzofurancarboxaldehyde; bis-(methyl thio)methane; 4-(methylthio)butanal; alpha-butylcinnamaldehyde; butyraldehyde; cinnamaldehyde; cis-4-heptenal; cis-5-isopropenyl-cis-2-metal cyclopentane-1-carboxaldehyde; citronelloxyacetaldehyde; cuminaldehyde; decanal; 2-decenal; 4-decenal; (+/−)-cis- and trans-1,2-dihydroperillaldehyde; 2,4-dimethyl benzaldehyde; 2,6-dimethyloctanal; 3,7-dimethyloctanal; 2,8-dithianon-4-en-4-carboxaldehyde; divanillin; 2-dodecenal; (Z)-4-dodecenal; 2,3-epoxydecanal; 4,5-epoxy-(E)-2-decenal; 2,3-epoxyheptanal; 2,3-epoxyoctanal; p-ethoxybenzaldehyde; 4-ethylbenzaldehyde; 2-ethylbutyraldehyde; 2-ethyl-2-heptenal; 2-ethyl-2-hexenal; 1-ethyl-2 pyrrolecarboxaldehyde; ethyl vanillin; ethyl vanillin beta-D-glucopyranoside; ethyl vanillin isobutyrate; farnesal; 2-formyl-6,6-dimethylbicyclo(3.3.1)hept-2-ene; furfural; 2-furfurylidenebutyraldehyde; 2,4-heptadienal; heptanal; 2-heptenal; trans-,trans-2,4-hexadienal; hexanal; 2-hexenal; 3-hexenal; cis-3-hexenal; trans-3-hexenal; cis-4-hexenal; trans-4-hexenal; alpha-hexylcinnamaldehyde; 2-hexylidenehexanal; 4-hydroxybenzaldehyde; hydroxycitronellal; 4-hydroxy-3,5-dimethoxybenzaldehyde; 2-hydroxy-4-methoxybenzaldehyde; 2-hydroxy-4-methylbenzaldehyde; isobutyraldehyde; 2-isopropyl-5-methyl-2-hexenal; p-isopropylphenylacetaldehyde; 3-(p-isopropylphenyl)propionaldehyde; IVY carbaldehyde; lauric aldehyde; p-menth-1-ene-9-al; 3-mercapto-2-methylpentanal; p-methoxy-alpha-methylcinnamaldehyde; o-methoxybenzaldehyde; p-methoxybenzaldehyde; o-methoxycinnamaldehyde; p-methoxycinnamaldehyde; 2-methyl-3-(2-furyl)acrolein; 2-methyl-2-butenal; 3-methyl-2-butenal; 2-methylbutyraldehyde; 3-methylbutyraldehyde; alpha-methylcinnamaldehyde; p-methylcinnamaldehyde; 3-(3,4-methylenedioxyphenyl)-2-methylpropanal; 5-methylfurfural; 3-(5-methyl-2-furyl)-butanal; 3-(5-methyl-2-furyl)prop-2-enal; 3-[(2-methyl-3-furyl)thio]butanal; 6-methylheptanal; 3-methylhexanal; 1-methyl-1H-pyrrole-2-carboxaldehyde; 4-methyl-2-(methylthiomethyl)-2-hexenal; 5-methyl-2-(methylthiomethyl)-2-hexenal; 4-methyl-2-(methylthiomethyl)-2-pentenal; 2-methyloctanal; (+/−)-6-methyloctanal; 2-methyl-2-octenal; 2-methylpentanal; 2-methyl-2-pentenal; 4-methyl-2-pentenal; 2-methyl-4-phenylbutyraldehyde; 3-methyl-2-phenylbutyraldehyde; 5-methyl-2-phenyl-2-hexenal; 4-methyl-2-phenyl-2-pentenal; 2-methyl-2-(methyldithio)propanal; 2-methyl-3-(p-isopropylphenyl)propionaldehyde; 2-methylthioacetaldehyde; 3-(methylthio)butanal; 2-((methylthio)methyl)-2-butenal; 2-(methylthiomethyl)-3-phenylpropenal; 5-methyl-2-thiophenecarboxaldehyde; 3-(methylthio)propionaldehyde; 2-methyl-2-tolylpropionaldehyde (mixed o-, m-, p-); 12-methyltridecanal; 2-methylundecanal; (+/−)-2-(5-methyl-5-vinyltetrahydrofuran-2-yl)propionaldehyde; myristaldehyde; 2,4-nonadienal; 2-trans-6-trans-nonadienal; 2,6-nonadienal diethyl acetal; nonanal; nona-2,4,6-trienal; 2-nonenal; cis-6-nonenal; 9-octadecenal; trans-,trans-2,4-octadienal; 2-trans-6-trans-octadienal; octanal; 2-octenal; cis-5-octenal; paraldehyde; 2,4-pentadienal; 2-pentenal; 4-pentenal; perillaldehyde; phenylacetaldehyde; 2-phenyl-2-butenal; (+/−)-2-phenyl-4-methyl-2-hexenal; 2-phenyl-4-pentenal; 3-phenyl-4-pentenal; 2-phenyl-3-(2-furyl)-prop-2-enal; 2-phenylpropionaldehyde; 3-phenylpropionaldehyde; piperonal; 1,3-p-menthadien-7-al; propionaldehyde; pyruvaldehyde; salicylaldehyde; tetradic-2-enal; (Z)-8-tetradecenal; tolualdehydes (mixed o-, m-, p-); p-tolylacetaldehyde; 2-(p-tolyl)-propionaldehyde; 2-trans,6-cis-dodecadienal; 2-trans-6-cis-nonadienal; trans-4-nonenal; trans-,trans-2,4-dodecadienal; tridecanal; 2-trans-,4-cis,7-cis-tridecatrienal; 2-tridecenal; 2,6,6-trimethyl-1 and 2-cyclohexen-1-carboxaldehyde; 2,6,6-trimethylcyclohexa-1,3-dienyl methanal; 2,6,6-trimethyl-1-cyclohexen-1-acetaldehyde; 2,2,3-trimethylcyclopent-3-en-1-yl acetaldehyde; 3,5,5-trimethylhexanal; 2,4-undecadienal; gamma-undecalactone; undecanal; (E)-4-undecanal; 10-undecenal; 2-undecenal; 9-undecenal; valeraldehyde; vanillin; vanillin acetate; vanillin isobutyrate; veratraldehyde; and combinations of two or more of the foregoing.

4. The aldehyde-containing dry powder composition of claim 1, wherein the at least one aldehyde ingredient comprises an aldehyde selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; undecenal; pentanal; 2-phenyl propionaldehyde; 3-phenyl propionaldehyde; hydroxybenzaldehyde; heliotropine; vanillin; geranial; neral; raspberry ketone; hydroxycitronellal; C₇-C₁₈ fatty aldehydes; 3,5-dimethyl-3-cyclohexene-1-carboxaldehyde; 4-(4-hydroxy-4-methylpentyl)-3-cyclohexene-1-carboxaldehyde; and combinations of two or more of the foregoing.

5. The aldehyde-containing dry powder composition of claim 1, wherein the at least one aldehyde ingredient comprises an aldehyde selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; nonanal; 4-methyl-2-phenyl-2pentenal A; nonadienal 2, 4; nonenal; 2-methylbutyraldehyde; heptanal; phenylacetaldehyde; cyclamen aldehyde; 2,4-decadienal; perilla aldehyde; 5-methyl furfural; decenal; undecanal; pentanal; 2-phenyl propionaldehyde; 3-phenyl propionaldehyde; hydroxybenzaldehyde; heliotropine; vanillin; geranial; neral; raspberry ketone; and combinations of two or more of the foregoing.

6. The aldehyde-containing dry powder composition of claim 1, wherein the at least one aldehyde ingredient comprises an aldehyde selected from the group consisting of benzaldehyde; acetaldehyde; furfural; isovaleraldehyde; decanal; hexenal trans-2; hexenal; melonal; nonadienal; isobutyraldehyde nat; prenal; anisaldehyde; octanal; anisic aldehyde; cinnamic aldehyde; and combinations of two or more of the foregoing.

7. The aldehyde-containing dry powder composition of claim 1, wherein the at least one aldehyde ingredient comprises an aldehyde selected from the group consisting of benzaldehyde; acetaldehyde; furfural; hexenal; hexenal trans-2; vanillin; and combinations of two or more of the foregoing.

8. The aldehyde-containing dry powder composition of claim 1, wherein the at least one aldehyde ingredient comprises an aldehyde selected from the group consisting of: benzaldehyde; anisic aldehyde; C₇-C₁₈ fatty aldehydes; vanillin; hexyl cinnamic aldehyde; hydroxycitronellal; 3,5-dimethyl-3-cyclohexene-1-carboxaldehyde; 4-(4-hydroxy-4-methylpentyl)-3-cyclohexene-1-carboxaldehyde; and combinations of two or more of the foregoing.

9. The aldehyde-containing dry powder composition of claim 1, wherein the carrier comprises at least one selected from the group consisting of polysaccharides, proteins, gums, esters, lipids, waxes, and synthetic polymers.

10. The aldehyde-containing dry powder composition of claim 1, wherein the carrier comprises at least one selected from the group consisting of starches, modified food starches, native starches, maltodextrins, alginates, pectins, methylcellulose, ethylcellulose, hydrocolloids, inulin, carbohydrates, mono-, di- and tri-saccharides, soluble fibers, polydextrose, animal proteins, plant proteins, caseinates, gelatins, soy proteins, pea proteins, whey proteins, milk proteins, guar gum, xanthan gum, acacia gum (gum arabic), gellan gum, caragenan, polysorbates, stearic acid esters, oleic acid esters, coconut oil, medium chain triglyceride (MCT) oils, vegetable oils, sunflower oils, palm oils, carnauba waxes, bee waxes, polyvinylpyrrolidone, polyvinylalcohol, polyacrylamides, polyvinyl acetate, polyethylene oxide, and polyacrylic acid.

11. The aldehyde-containing dry powder composition of claim 1, wherein the carrier comprises starch.

12. The aldehyde-containing dry powder composition of claim 1, wherein the carrier comprises at least one selected from the group consisting of maltodextrin, cyclodextrin, and gum arabic.

13. The aldehyde-containing dry powder composition of claim 1, wherein the carrier comprises at least one selected from the group consisting of cellulose, methylcellulose, and ethylcellulose.

14. The aldehyde-containing dry powder composition of claim 1, wherein the carrier comprises at least one selected from the group consisting of whey protein, soy protein, and gelatin.

15. The aldehyde-containing dry powder composition of claim 1, wherein the carrier comprises at least one selected from the group consisting of polyvinylpyrrolidone, polyvinylalcohol, polyacrylamides, polyvinyl acetate, polyethylene oxide, and polyacrylic acid.

16. The aldehyde-containing dry powder composition of claim 1, wherein the emulsifier comprises at least one selected from the group consisting of polysorbates, sodium caseinate, low methoxy pectin, gelatin, L-a-dipalmitoyl-phosphatidylcholine (DPPC), cholesterol, polyvinyl alcohol (PVA), sodium stearoyl lactylate, mono- and di-glycerols, ammonium phosphatide, locust bean gum, xanthan gum, and citrem.

17. The aldehyde-containing dry powder composition of claim 1, wherein the carrier and emulsifier are constituted by a same ingredient having carrier and emulsifier properties.

18. The aldehyde-containing dry powder composition of claim 1, wherein aldehyde ingredient(s) loading is from 2 to 50% by weight, based on weight of the carrier in the aldehyde-containing powder composition.

19. The aldehyde-containing dry powder composition of claim 1, wherein weight percent aldehyde ingredient(s) loading, based on weight of the carrier in the aldehyde-containing powder composition, is greater than at least one of %, 32%, 4%, 5%, 6%, 7%, 8%, 9%, 10%, 12%, 15%, 18%, 20%, 22%, 25%, 28%, 30%, 32%, 35%, 38%, 40%, 42%, 44%, 45%, 46%, 47%, 48%, and up to 50% by weight.

20. The aldehyde-containing dry powder composition of claim 1, wherein weight percent aldehyde ingredient(s) loading, based on weight of the carrier in the aldehyde-containing powder composition, is in a range in which the lower end point value is 2%, 3%, 4%, 5%, 6%, 7%, 8%, 9%, 10%, 12%, 15%, 18%, 20%, 22%, 25%, 28%, 30%, 32%, 35%, 38%, 40%, 42%, 44%, 45%, 46%, 47%, 48%, or 50%, and the upper end point value is 120. Of the foregoing numeric values exceeding the lower end point value.

21. The aldehyde-containing dry powder composition of claim 1, wherein weight percent aldehyde ingredient(s) loading, based on weight of the carrier in the aldehyde-containing powder composition, is in a range of from 2% to 40%, a range of from 10% to 50%, a range of from 3% to 30%, a range of from 5% to 42%, a range of from 2% to 20%, or a range of from 12% to 35%.

22. The aldehyde-containing dry powder composition of claim 1, having a particle size distribution of the powder in which at least 50% of powder particles have a size in a range of from 25 μm to 250 μm.

23. The aldehyde-containing dry powder composition of claim 1, wherein at least 75%, 80%, 85%, 88%, 90%, 91%, 92%, 94%, or 95% of particles in the powder composition have particle size of at least one of 80 μm, 85 μm, 90 μm, 95 μm, 100 μm, 110 μm, 120 μm, 130 μm, 140 μm, 150 μm, 160 μm, 170 μm, 180 μm, 190 μm, and 200 μm.

24. The aldehyde-containing dry powder composition of claim 1, having an average particle size in a range of from 40 μm to 300 μm.

25. The aldehyde-containing dry powder composition of claim 1, wherein powder particles in the powder composition have a powder particle void volume that is less than at least one of 15%, 14%, 13%, 12%, 11%, 10%, 9%, 8%, 7%, 6%, 5%, 4%, 3%, 2%, 1%, or 0.5% of the total particle volume.

26. The aldehyde-containing dry powder composition of claim 1, having a weight percent moisture content that is less than at least one of 7%, 6%, 5%, 4.5%, 4%, 3.5%, 3%, 2.75%, 2.5%, 2.25%, 2%, 1.8%, 1.7%, 1.6%, 1.5%, 1.4%, 1.3%, 1.2%, 1.1%, 1.0%, 0.9%, 0.8%, 0.75%, 0.7%, 0.65%, 0.6%, 0.55%, 0.5%, 0.45%, 0.4%, 0.35%, 0.3%, 0.25%, 0.2%, 0.15%, and 0.1%, based on total weight of the aldehyde-containing powder composition.

27. The aldehyde-containing dry powder composition of claim 1, having a bulk density in a range of from 0.8 to 1.4 g/ml.

28. A method of using the aldehyde-containing dry powder composition of claim 1, comprising formulating or processing the aldehyde-containing powder composition with one or more additional components to constitute a final product.

29. The method of claim 28, wherein the final product is a product in which the at least one aldehyde ingredient comprises an organoleptic aldehyde ingredient of the final product.

30. The method of claim 29, wherein the organoleptic aldehyde ingredient is an aldehyde flavor ingredient.

31. The method of claim 30, wherein the final product is a product selected from the group consisting of foods, beverages, nutritional supplements, pharmaceutical products, therapeutic products, medication products, homeopathic products, biological products, and probiotic products.

32. The method of claim 30, wherein the final product is a ready-to-drink (RTD) flavored beverage product that is formed by adding the aldehyde-containing dry powder composition to a drinkable liquid.

33. The method of claim 29, wherein the organoleptic aldehyde ingredient is an aldehyde fragrance ingredient.

34. The method of claim 33, wherein the final product is a product selected from the group consisting of perfumes, colognes, toilet waters, shampoos, soaps, deodorants, detergents, body washes, air fresheners, candles, waxes, apparel, packaging, cosmetics, hygiene products, skincare products, detergents, cleaning products, and aromatherapy products.
